(19) United States
(12) Patent Application Publication
(10) Pub. No.: US 2005/0249039 A1
(43) Pub. Date: Nov. 10, 2005

(54) Rapidly deployable, three-dimensional seismic recording system

(76) Inventors: Patrick Francis Miller, Townsend, MT (US); Marvin A. Speece, Melrose, MT (US); Curtis A. Link, Butte, MT (US)

Correspondence Address: Antoinette M. Tease, P.L.L.C., PO Box 51016, Billings, MT, 59105, US

(21) Appl. No.: 10/840,442

(22) Filed: May 6, 2004

(51) Int. Cl. H04R 1/00

(52) U.S. Cl. 367/177

(57) ABSTRACT

A mobile, easily deployable, three-dimensional seismic recording system suitable for shallow seismic reflection or refraction surveys. The system comprises a towing unit, a reel assembly system, a towing frame, and one or more streamers. Each streamer comprises a rubber mat and a plurality of geophones. The geophones are placed on top of the rubber mat, a hole is cut in the rubber mat beneath each geophone, and each geophone is held in place on the rubber mat by a rubber pad that is placed on top of the geophone and secured to the rubber mat with a plurality of bolts. Streamer spacers, each of which comprises a plurality of frames and a cross-bar connecting the frames, are used to secure the streamers to each other when a measurement is being taken. A method for taking seismic measurements using the seismic recording system described herein.

### STATEMENT REGARDING FEDERALLY SPONSORED RESEARCH OR DEVELOPMENT

This invention was made with Government support under grant number DMI-0239071 awarded by the National Science Foundation. The Government has certain rights in this invention.

### BACKGROUND OF THE INVENTION

1. Field of the Invention

The present invention provides a mobile, easily deployable, three-dimensional seismic recording system suitable for shallow seismic reflection or refraction surveys.

2. Description of the Related Art

On land, a suitable energy source, such as a sledgehammer striking the ground, generates elastic waves. These waves travel through the subsurface until they encounter boundaries of contrasting elastic properties. At these boundaries, part of the propagating energy is reflected or refracted back to the ground surface, where receivers called geophones sense the returning wave energy. Typically, geophones are coupled to the ground surface by means of a long spike at the base of the geophone that is driven into the ground. The signal received by the geophone can then be digitized and recorded for subsequent processing. The goal of the seismic reflection method is to use the recorded reflected seismic energy to build an image of the subsurface by reconstructing the boundaries that generated the reflections.

Two-dimensional (2-D) seismic reflection data are used to construct a picture of the subsurface immediately beneath the profile line from which the data are collected. These data are collected by deploying multiple geophones in a line along the profile direction with the goal of determining spatial relations in two dimensions-along the profile direction and in depth. The data, however, cannot resolve reflections from out of the recording plane that commonly occur in areas of complex geology. As a consequence, three-dimensional (3-D) data are needed to properly reconstruct accurate images. Moreover, 3-D data are useful for target identification. For instance, buried building foundations could appear as a diffraction hyperbola on a 2-D profile and be mistaken for a buried pipe or other point diffractor. Such a mistake can often be avoided with a 3-D image because the interpreter can gain knowledge about the shape of the target.

Three-dimensional seismic reflection data are acquired by deploying geophones on an areal surface grid with the goal of determining spatial relations in three dimensions. For land work, 3-D data are desirable but considerably more costly to acquire than 2-D data because numerous workers must manually deploy individual geophones and associated cabling. In marine seismic work, however, the deployment of multiple streamers of receivers (hydrophones) to form the areal grid minimizes the cost of acquiring 3-D data. A boat then pulls the multi-streamer array through the water to quickly and efficiently record 3-D data.

The need to reduce the cost of land seismic reflection data collection has inspired other researchers to consider the use of a towed land cable or streamer in a fashion similar to that done in marine work. In the case of data collected using a land streamer, data are not collected in a continuous fashion; the streamer is pulled to a stop at each station location, data are collected, and then the cable is dragged to the next station. The land streamer is usually built using gimbal-mounted geophones in which ground coupling is accomplished through the geophone housing that is dragged along the ground surface [1]. An early version of a land streamer was used to collect seismic data on sea ice in arctic North America [2], but no detailed report of this system's performance was ever published. Using a similar design, a land streamer was utilized in Antarctica [3], and later, an improved version was used in Svalbard and Antarctica [4]. In these studies, extensive comparisons between gimbal-mounted geophones and planted spiked geophones were made, and no significant differences between them could be seen [4].

Currently, marine seismic crews deploy gimbaled geophone streamers on the ocean bottom and obtain good seismic reflection data. More recently, a land steamer was designed specifically for efficient, shallow, seismic data acquisition in which the geophones have a much closer spacing than is used for deeper petroleum work [5]. This streamer used gimbaled, vertically oriented P-wave geophones. Data gathered in Switzerland with this streamer were practically indistinguishable from data recorded with conventional spiked geophones at the same location. Furthermore, Inazaki [6] and Inazaki and Kano [7] show good results using a land streamer with S-wave geophones clamped to non-expandable belts. In this system, conventional S-wave geophones are coupled to the ground through small aluminum plates that are affixed to the belts. All of these studies were done with conventional 2-D land recording techniques. To date, no attempt has been made to build a system to efficiently collect shallow 3-D seismic reflection data by pulling multiple parallel land streamers on land.

It is an object of the present invention to provide a mobile, easily deployable, three-dimensional seismic recording system suitable for shallow seismic reflection surveys. It is a further object of the present invention to provide a system that records seismic reflection data with quality equivalent to a conventional recording system. The present invention seeks to accomplish these objectives while providing a low environmental impact and a rugged system.

### BRIEF SUMMARY OF THE INVENTION

The present invention is a seismic recording system comprising a towing unit, a reel assembly system, a towing frame, and one or more streamers. In the preferred embodiment, the towing unit is the LAND TAMER all-terrain vehicle. The reel assembly comprises a plurality of reels, the number of reels is equal to the number of streamers, and the reels have a common shaft. The towing frame can be raised or lowered, and it comprises a means for attaching the streamers to the towing frame. The seismic recording system further comprises two bogey wheels, which are attached to the towing frame and which redistribute the weight of the reel assembly system.

Each streamer comprises a rubber mat and a plurality of geophones. The geophones are preferably dual-gimbaled geophones. The geophones are placed on top of the rubber mat, a hole is cut in the rubber mat beneath each geophone, and each geophone is held in place on the rubber mat by a rubber pad that is placed on top of the geophone and secured to the rubber mat with a plurality of bolts. To provide added stability to the geophones, a steel rod is optionally placed through the cap of each of the geophones to prevent the geophone from falling through the hole in the rubber mat. The geophones are connected to one another by a streamer cable that is longer than the rubber mat.

In the preferred embodiment, there are four streamers. Each streamer holds twenty-four geophones spaced one meter apart, and the streamers are spaced one meter apart. In this particular embodiment, in order to facilitate the rapid deployment of the streamers, each reel has an inside diameter of approximately one meter and an outside diameter of approximately one and one-half (1.5) meters.

The seismic recording system further comprises at least one set of streamer spacers. The purpose of the streamer spacers is to hold the streamers in place when they are deployed on the ground and a measurement is being taken. Each set of streamer spacers comprises a plurality of frames and a cross-bar connecting the frames. The number of frames is equal to the number of streamers, each frame is attached to a rubber mat, and only one frame is attached to each rubber mat.

The present invention includes a method for taking seismic measurements using the seismic recording system described herein.

### BRIEF DESCRIPTION OF THE DRAWINGS

FIG. 1 is a top view of the major system components, shown with the geophone system in the measurement position.

FIG. 2 is a partial top view of the system, showing the transport unit, the computer control units, and the streamer connection components.

FIG. 3 is a side view of the major system components, shown with the geophone system in the measurement position.

FIG. 4 is a partial side view of the system, showing the transport unit, the computer control units, and the streamer connection components.

FIG. 5 is a top view of a geophone unit attached to the rubber mat of the streamer.

FIG. 6 is a side view of a geophone unit attached to the rubber mat of the streamer.

FIG. 7 is a partial perspective view of the streamers and streamer spacers.

FIG. 8 is a simplified perspective view of the reel assembly shown in relation to the bogey wheels and the wheels of the transport unit.

FIG. 9 is a rear view of a reel with the streamer wrapped around it.

FIG. 10 is a section view of a reel with the streamer wrapped around it taken at line 10-10 of FIG. 9.

FIG. 11 is a detail view of a portion of FIG. 10, showing the relative positions of the rubber mat, the geophone and the streamer cable when these components are wrapped around the reel.

### DETAILED DESCRIPTION OF THE INVENTION

The objective of the present invention is to provide an improved method for carrying out land and transition zone seismic data acquisition. The system of the present invention includes a means for a rapidly deployable two-dimensional array of ground motion sensors. The array of sensors is dragged along the ground surface to collect seismic data with the goal of determining spatial relations of features in the subsurface in three dimensions within the surveyed area.

The present invention allows the use of modern, three-dimensional seismic recording technology in venues where it was previously not economically feasible. In environmental applications, where the depth of interest is often less than 300 meters, the 3-D seismic recording system of the present invention can be effectively used to build models of ground water flow, track pollutants, and identify mineral-laden zones. In engineering applications, this system can be used to aid in the siting of large construction projects. Engineering firms that have a need for shallow subsurface investigations will be able to choose the seismic reflection technique of the present invention over other low-resolution techniques or those that lack sufficient depth of penetration.

The present invention comprises an amphibious self-propelled vehicle with a cable reel mounted onto it. The cable reel has a series of individual receptacles into which one or more seismic cables with attached ground motion sensors are spooled. The reel has one or more recessed slots each containing an individually coiled seismic cable and associated attached flexible mat. While the cable vehicle moves forward, the cable reel is rotated to unspool each of the seismic cables onto the ground from their individual slots on the reel. In this way multiple parallel oriented seismic cables are deployed on the ground surface. After the cables are laid out on the ground, they are unattached from the cable reel and reattached to the back of the vehicle so that the cables can be dragged to different locations along the ground surface.

Each seismic cable consists of multiple connection nodes. At each connection node is attached a sensor string that consists of one or more self-orienting ground motion sensors. Each sensor is encased in a protective abrasion-resistant covering that is meant to be in contact with the ground when the system is deployed, thereby protecting the individual sensors while the cable is being dragged. Each cable lies on top of a long flexible support conveyance or mat. The mat absorbs abrasion from the ground as the mat and cable are dragged along the ground together. The width of the mat is considerably more than its thickness to prevent the mat from rotating or overturning. Each mat contains cutouts for each sensor casing so that the sensor casings can maintain contact with the ground. When the sensors are placed into these cutouts, they are secured inside the cutouts with a flexible backing that is connected to the top of the mat. The backing also serves to help couple the sensor casings to the ground by adding additional weight to the top of each sensor casing. Each mat and associated cable is attached and separated from each adjacent cable and mat by means of a rigid spacer that is attached to top of each mat. The spacers allow the mats to track along the ground surface together as a parallel oriented group while the cables and mats are being dragged. Moreover, the spacers are raised off the ground to allow for the passing of vegetation and other obstacles underneath the spacers and between the mats. The flexible mat is attached to the back of the cable vehicle and serves as the tension member while the vehicle pulls that cable and mat together along the ground.

After the multiple parallel cables are deployed on the ground in a two-dimensional surface grid, seismic energy is introduced into the ground with a suitable seismic source. As this energy returns to the ground surface, the ground-motion sensors detect this energy, and the sensor ground-motion measurements are recorded. The source can then be moved to a new location so that energy can be received at the sensor array from different directions. After recording is finished at one location, the sensor array is dragged forward to a new location for further recording. As the sensor array advances, a large area can be covered and a three-dimensional image can be generated showing the subsurface features underneath the surveyed area.

After the seismic survey is completed, the cables and mats are spooled back onto the cable reel by moving the cable vehicle backward as the reel winds the cable and mat up into each cables reel receptacle. The vehicle can then be driven to the next location, where the process begins again. Although the above description relates to seismic reflection surveys, the present invention can also be used in connection with seismic refraction surveys.

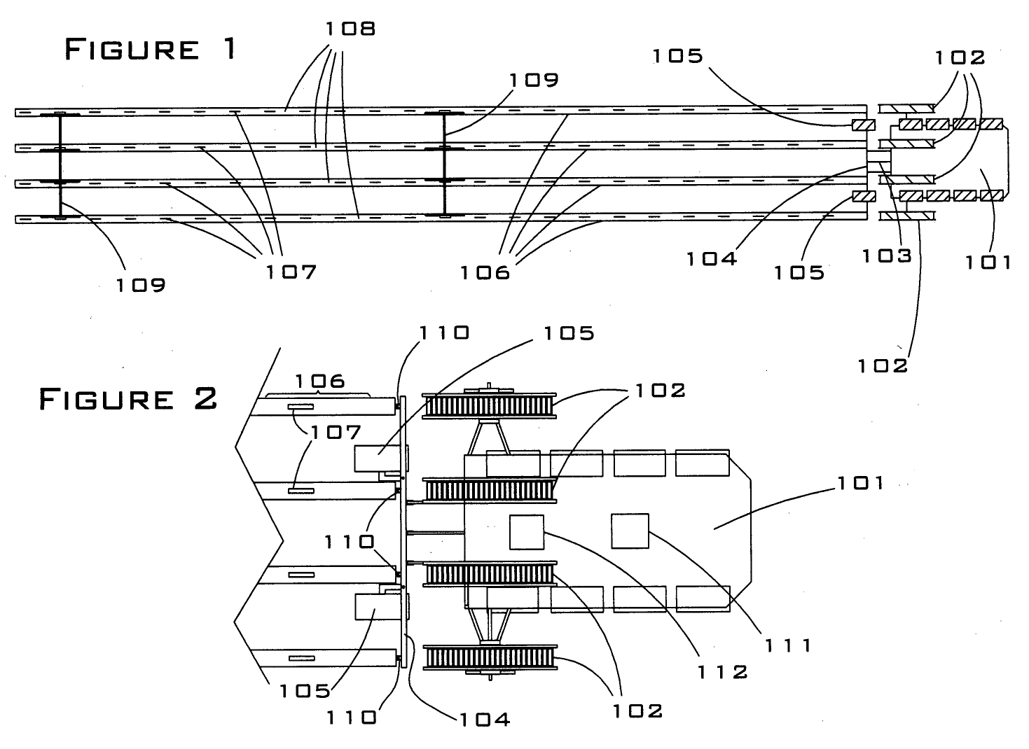

FIG. 1 is a top view of the major system components, shown with the geophone system in the measurement position. This figure shows the transport unit 101, the reel system 102, the three-point hitch 103, the towing frame 104, the bogey wheels 105, the streamers 106, the geophones 107, and the streamer spacers 109. In the preferred embodiment, the transport unit 101 is the LAND TAMER all-terrain vehicle (ATV). The reel system 102 comprises four reels around which the streamers are wrapped when the system is not being used to take measurements. In the preferred embodiment, the streamers, when deployed for the purpose of taking a seismic measurement, are attached to a towing frame 104, which is attached to the transport unit 101 by a three-point hitch 103. The three-point hitch 103 is operated by a hydraulic cylinder that ensures the towing vehicle, when raised or lowered, supports the weight of the system.

Bogey wheels 105 are attached to the towing frame 104 to provide added stability and to take some of the weight of the reel system 102 off the rear of the transport unit 101. Because they are attached to the towing frame 104, the bogey wheels can also be raised or lifted by the same hydraulic motor that raises or lifts the towing frame 104 and the three-point hitch 103. The streamers 106 comprise geophones 107 evenly spaced on a rubber mat 108. The streamer spacers 109 (shown in greater detail in FIG. 7) ensure that the streamers remain stationary when they are deployed on the ground, and they also prevent the streamers from fishtailing.

In designing the preferred embodiment of the present invention, decisions were made about geophone spacing, cable spacing and maximum source-to-receiver separation distance to achieve optimal images of the subsurface. The preferred embodiment depicted in FIG. 1 provides improved data resolution and protection for the streamer cables, yet is still well within the towing capacity of the LAND TAMER ATV. The array consists of four land streamers 106 spaced one meter apart. Each streamer contains twenty-four (24) individual geophones 107, each spaced one meter apart, for a total of ninety-six (96) geophones covering a rectangular area of sixty-nine (69) square meters. Other separations can be deployed for changes in target depth, and the present invention is not limited to any particular separation of streamers or geophones.

FIG. 2 is a partial top view of the system, showing the transport unit, the computer control units, and the streamer connection components. As shown in this figure, each streamer 106 is attached to the towing frame 104 by a hook on the end of the streamer (not shown), which is placed through an eyelet 110 that protrudes from the towing frame 104. The eyelets 110 are placed directly behind each reel 102 so that the streamers can easily be detached from the reels and attached to the towing frame. The towing frame is then lowered into position, bringing the streamers closer to the ground.

This figure also shows the computer control units, which include an on-board laptop data processor 111 and a seismic cable interface module 112. The laptop computer contains a seismic software package that collects and stores the data on the vehicle. The seismic cable interface module is the interface that converts the collection data from the streamers into a format that can be read by the laptop computer.

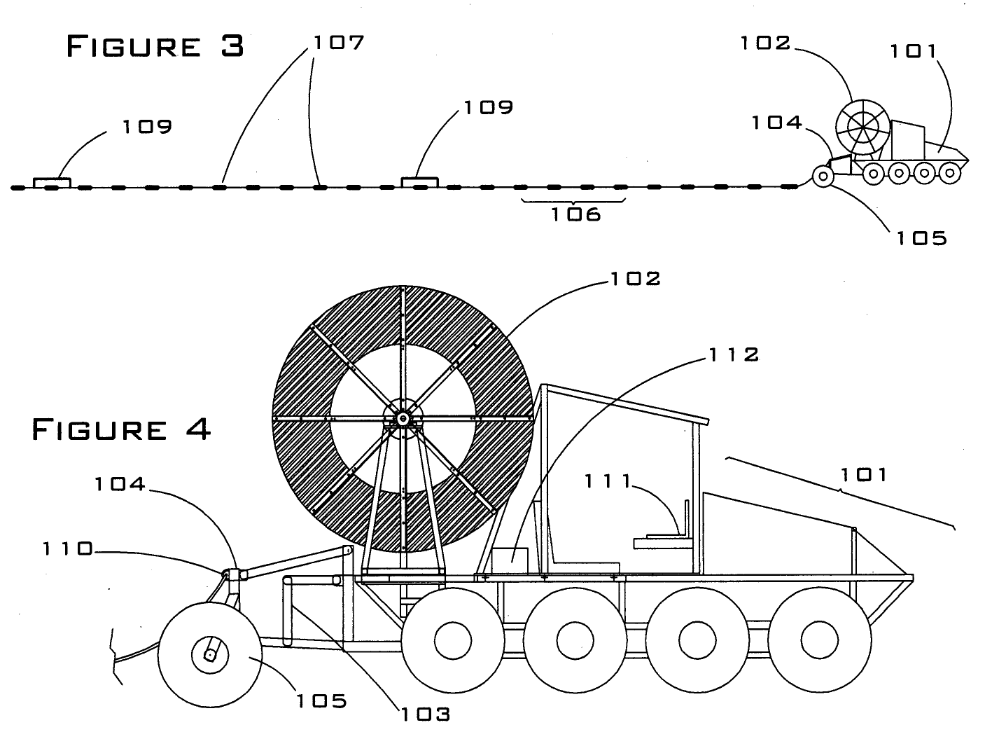

FIG. 3 is a side view of the major system components, shown with the geophone system in the measurement position. This figure shows the transport unit 101, the reel system 102, and the bogey wheels 105. The streamer 106 is attached to the towing frame 104, and the geophones are shown 107, as are the streamer spacers 109. In the preferred embodiment, there are two sets of streamer spacers. One set is placed at the far end of the streamers, and the other set is placed in the middle of the streamers. This arrangement provides for the greatest stability of the streamer configuration.

FIG. 4 is a partial side view of the system, showing the transport unit, the computer control units, and the streamer connection components. This figure shows the transport unit 101, the on-board laptop data processor 111, and the seismic cable interface module 112. It also shows the outermost reel 102. In the preferred embodiment, the inside diameter of each reel is approximately one meter, and the outside diameter is approximately one and one-half (1.5) meters. This figure also shows the three-point hitch 103, the towing frame 104 with eyelets 110, and the bogey wheels 105.

The reel system 102 is used to rapidly deploy the streamers in the field and to quickly gather the streamers after a seismic survey is completed. In the preferred embodiment, the reel system 102 can accommodate the necessary torque required to gather four streamers of twenty-four (24) geophones at a time. A hydraulic motor that is driven by the onboard hydraulic pump of the LAND TAMER provides the necessary torque. The streamers of the preferred embodiment are equipped with a quick release receptacle that allows the streamer to be connected and disconnected quickly from the seismic recording system when the streamers are reeled in and out. The system of the present invention can work with a variety of commercially available seismic recording systems. In the preferred embodiment, a second LAND TAMER ATV (not shown) is outfitted with the seismic source.

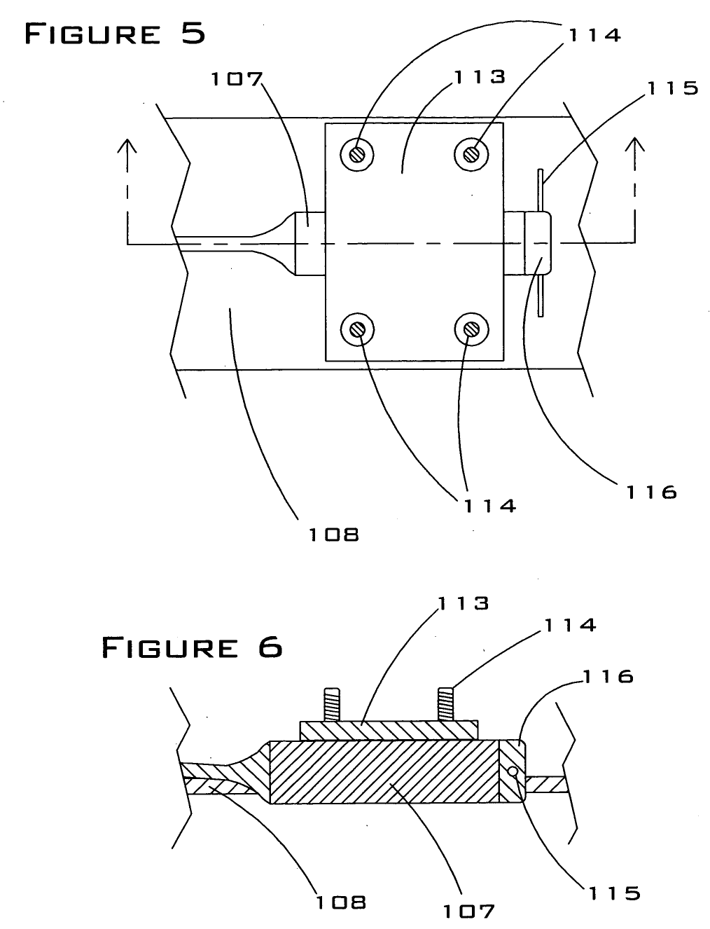

FIG. 5 is a top view of a geophone unit attached to the rubber mat of the streamer. In order to provide the maximum amount of stability while allowing the geophones to couple with the ground, a hole is cut in the rubber mat 108 for each geophone 107. In this figure, the hole in the rubber mat is not shown because it is beneath the geophone. The hole is large enough to allow the geophone to touch the ground so as to provide adequate coupling. Each geophone is held in place by a rubber pad 113 that is secured on top of the geophone with bolts 114. The rubber pad 113 provides for improved sensor coupling and better tracking. The bolts 114 run through the rubber pad 113 on top of the geophone and the rubber mat underneath the geophone 108. To ensure that the geophone will not fall through the hole in the rubber mat, a steel rod 115 is inserted through the geophone cap 116.

In the preferred embodiment, the geophone is a dual-gimbaled geophone. A dual-gimbaled geophone is free to rotate on two axes, which is particularly suited to the application of the present invention. If the cylinder case of the geophone is laid on uneven ground, the sensing element can orient itself to remain vertical even if the cylindrical casing is free to “roll” through 360 degrees. In addition, the sensing element remains vertical if the long axis of the cylinder is tilted, that is, if the front end of the cylinder is higher than the back end. The dual-gimbaled geophone arrangement allows the geophones to be dragged to a position and not have to be oriented manually, which contributes to the rapid deployment aspect of the present invention.

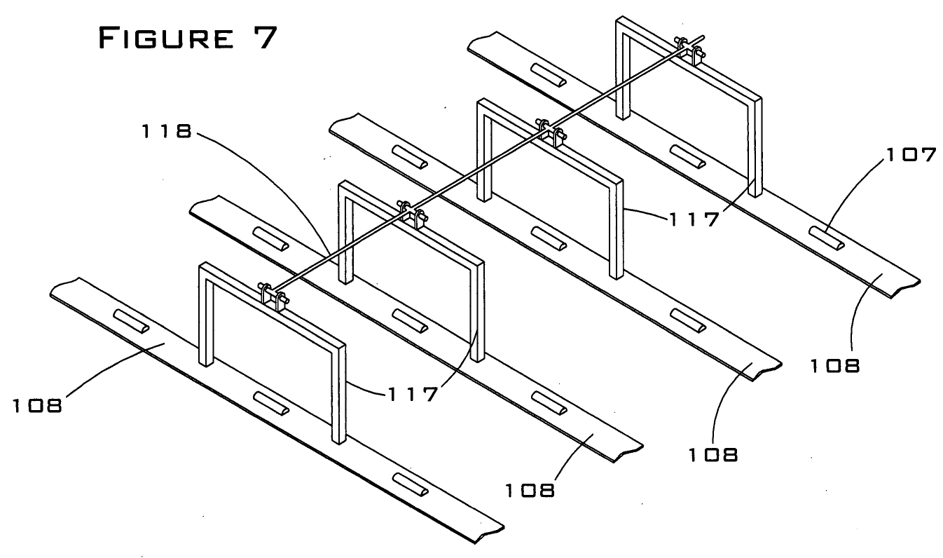

FIG. 6 is a side view of a geophone unit attached to the rubber mat of the streamer. It shows the geophone 107, the rubber mat 108, and the rubber pad 113 that is secured on top of the geophone with bolts 114. It also shows the geophone cap 116 and the steel rod 115 that is inserted through the cap.

FIG. 7 is a partial perspective view of the streamer spacers. The purpose of the streamer spacers is to keep the streamers in place once they have been deployed. Each set of streamer spacers comprises four frames 117, one for each streamer, and a cross-bar 118 that connects each of the frames and holds them in place. The frames are attached to the rubber mat 108 with bolts (not shown).

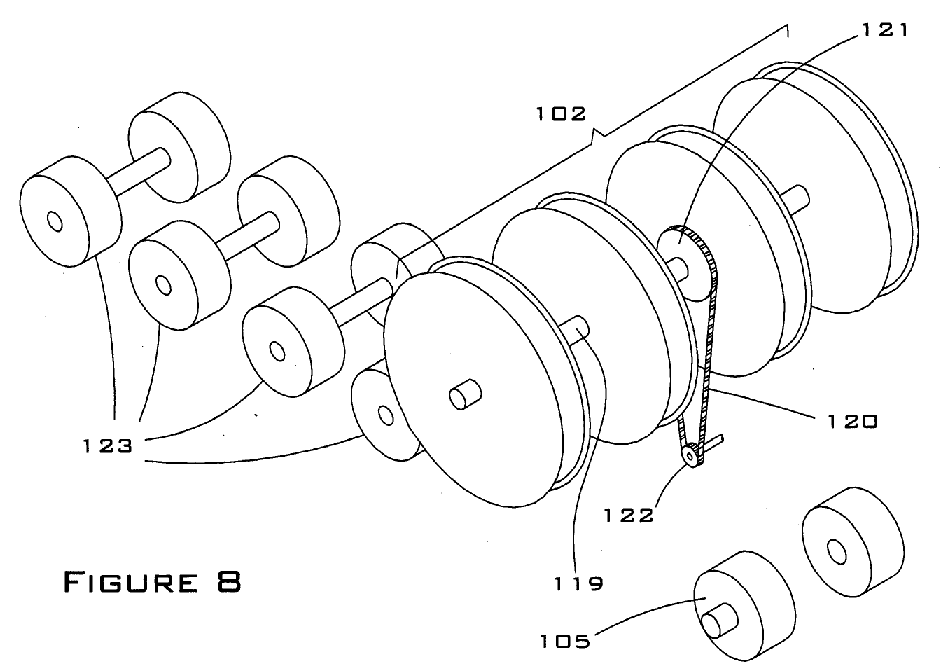

FIG. 8 is a simplified perspective view of the reel assembly shown in relation to the bogey wheels and the wheels of the transport unit. The reel assembly 102 comprises four reels, all of which share a common shaft 119. The shaft 119 is turned by a chain 120 that wraps around a larger sprocket 121 located adjacent to one of the inner reels and a smaller sprocket 122 located beneath the reel assembly. The bogey wheels 105 sit some distance behind the reel assembly 102, and the wheels of the transport unit 123 lie in front of the reel assembly. It is apparent from this picture that the bogey wheels are necessary to evenly distribute the weight of the reel system.

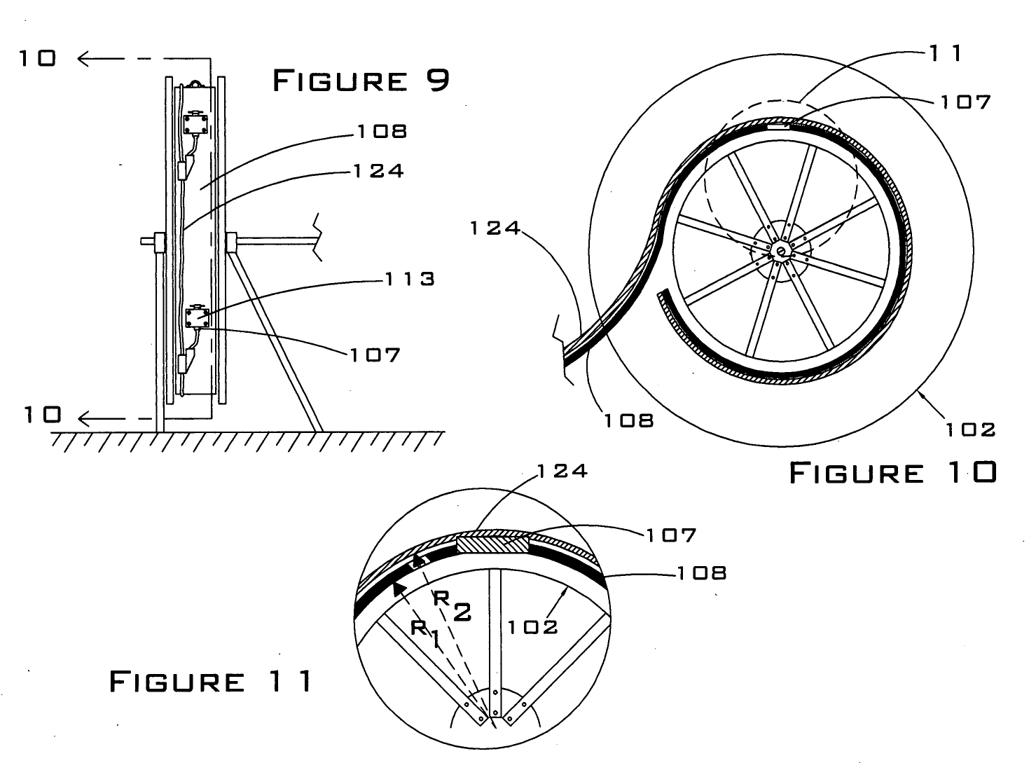

FIG. 9 is a rear view of a reel with the streamer wrapped around it. It shows the rubber mat 108 with the geophone 107 secured to the rubber mat 108 by an additional rubber pad 113 placed on top of the geophone. It also shows the streamer cable 124 that connects the geophones and that allows the seismic measurements to be taken. When the streamers are deployed, the streamer cable 124 lies on top of the rubber mat 108.

FIG. 10 is a section view of a reel with the streamer wrapped around it taken at line 10-10 of FIG. 9. As shown in this figure, when the streamer is wrapped around the reel 102, the rubber mat 108 lies on the bottom, and the streamer cable 124 lies on the top. FIG. 11 is a detail view of a portion of FIG. 10, showing the relative positions of the rubber mat 108, the geophone 107 and the streamer cable 124 when these components are wrapped around the reel. As illustrated in this figure, the radius of the reel as measured to the streamer cable 124 (R2) is slightly larger than the radius as measured to the rubber mat 108 (R1). Accordingly, with each successive turn of the reel, the streamer cable is reeled in by a slightly greater distance than the rubber mat. One of the challenges of the present invention was to provide enough slack in the streamer cable when it is deployed so that when it is wrapped back onto the reel, it will lie flat on the rubber mat. Accordingly, the preferred embodiment includes one meter of slack in the streamer cable. The precise amount of slack is dependent upon a number of factors, including the thickness of the rubber mat, the thickness of the geophones, the thickness of the streamer cable, the distance between geophones, and the diameter of the reels. It is this precise calibration that allows for the streamers to be rapidly deployed.

Although a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

### REFERENCES

1. Kruppenbach, J. A., and Bedenbender, J. W., 1976, Towed land cable: U.S. Pat. No. 3,954,154.
2. Einarsson, D., Brooks, L., Bennett, G., and White, A., 1977, Seismic survey on the Beaufort Sea Ice: Geophysics, 42, 148.
3. Determann, J., Thyssen, F., and Engelhardt, H., 1988, Ice thickness and sea depth derived from reflection seismic measurements on the central part of Filchner-Ronne Ice shelf: Annals of Glaciology, 11, 14-18.
4. Eiken, O., Degutsch, M., Riste, P., and Rod, K., 1989, Snowstreamer: an efficient tool in seismic acquisition, First Break 7, No. 9, 374-378.
5. van der Veen, M. and Green, A. G., 1998, Land streamer for shallow seismic data acquisition: Evaluation of gimbal-mounted geophones: Geophysics, Vol. 63, No. 4, 1408-1413.
6. Inazaki, T., 1999, Land streamer: a new system for high-resolution S-wave shallow reflection surveys: Proceedings of the Symposium on the Application of Geophysics to Engineering and Environmental Problems (SAGEEP), 207-216.
7. Inazaki, T., and Kano, N., 2000, Detailed structural survey of the shallow part of a buried active fault using high-resolution S-wave reflection and seismic cone penetration tests: Proceedings of the Symposium on the Application of Geophysics to Engineering and Environmental Problems (SAGEEP), 1225-1234.

1. A seismic recording system comprising:
(a) a towing unit;
(b) a reel assembly system;
(c) a towing frame; and
(d) one or more streamers.

2. The seismic recording system of claim 1, wherein the towing unit is the LAND TAMER all-terrain vehicle.

3. The seismic recording system of claim 1, wherein the reel assembly system comprises a plurality of reels.

4. The seismic recording system of claim 3, wherein the number of reels is equal to the number of streamers.

5. The seismic recording system of claim 3, wherein the reels have a common shaft.

6. The seismic recording system of claim 1, further comprising a means for raising or lowering the towing frame.

7. The seismic recording system of claim 1, wherein the towing frame comprises a means for attaching the streamers to the towing frame.

8. The seismic recording system of claim 7, wherein the reel assembly system comprises one or more reels, and wherein the means for attaching the streamers to the towing frame are eyelets located on the towing frame directly behind each reel.

9. The seismic recording system of claim 1, further comprising two bogey wheels.

10. The seismic recording system of claim 9, wherein the bogey wheels are attached to the towing frame.

11. The seismic recording system of claim 1, wherein each streamer comprises a rubber mat and a plurality of geophones.

12. The seismic recording system of claim 1 wherein the geophones are placed on top of the rubber mat, wherein a hole is cut in the rubber mat beneath each geophone, and wherein each geophone is held in place on the rubber mat by a rubber pad that is placed on top of the geophone and secured to the rubber mat with a plurality of bolts.

13. The seismic recording system of claim 12, wherein each geophone comprises a geophone cap, and wherein a steel rod is placed through the geophone cap.

14. The seismic recording system of claim 11, wherein the geophones are connected to one another by a streamer cable.

15. The seismic recording system of claim 14, wherein the cable streamer is longer than the rubber mat.

16. The seismic recording system of claim 11, wherein the geophones are dual-gimbaled geophones.

17. The seismic recording system of claim 1, further comprising at least one set of streamer spacers.

18. The seismic recording system of claim 1, wherein each set of streamer spacers comprises a plurality of frames and a cross-bar connecting the frames, and wherein the number of frames is equal to the number of streamers.

19. The seismic recording system of claim 18, wherein each streamer comprises a rubber mat and a plurality of geophones, wherein each frame is attached to a rubber mat, and wherein only one frame is attached to each rubber mat.

20. A seismic recording system comprising:
(a) a towing unit;
(b) a reel assembly system;
(c) a towing frame; and
(d) four streamers;
wherein each streamer comprises a rubber mat and twenty-four geophones spaced one meter apart on the streamer, and wherein the streamers are spaced one meter apart.

21. The seismic recording system of claim 20, wherein each streamer further comprises a streamer cable, and wherein the streamer cable is one meter longer than the rubber mat.

22. A seismic recording system comprising:
(a) a towing unit;
(b) a reel assembly system;
(c) a towing frame; and
(d) one or more streamers;
wherein each streamer comprises a rubber mat and twenty-four geophones spaced one meter apart on the streamer, wherein the reel assembly system comprises a plurality of reels, wherein the number of reels is equal to the number of streamers, wherein the inside diameter of each reel is approximately one meter, and wherein the outside diameter of each reel is approximately one and one-half (1.5) meters.

23. A method of taking seismic measurements using the seismic recording system of claims 1, 20 or 22.
